(19) United States
(12) Patent Application Publication
(10) Pub. No.: US 2025/0079045 A1
(43) Pub. Date: Mar. 6, 2025

(54) COMMUNICATION CABLE AND COMMUNICATION CABLE ASSEMBLY

(71) Applicant: HIRAKAWA HEWTECH CORPORATION, TOKYO (JP)

(72) Inventor: Tomoki KUMAGAI, Date-shi (JP)

(21) Appl. No.: 18/799,541

(22) Filed: Aug. 9, 2024

(30) Foreign Application Priority Data
Sep. 1, 2023 (JP) 2023-142524

(51) Int. Cl. H01B 11/10

(52) U.S. Cl. CPC H01B 11/1091

(57) ABSTRACT

A communication cable includes two first differential pair wires for transmitting high-speed differential signals, a second differential pair wire for transmitting low-speed differential signals, a power wire, a ground wire, and a configuration channel wire for detecting the front and back orientation of a plug, and the communication cable is devoid of other first differential pair wires than the two first differential pair wires.

### CROSS-REFERENCE TO RELATED APPLICATIONS

The present patent application claims the priority of Japanese patent application No. 2023-142524 filed on Sep. 1, 2023, and the entire contents thereof are hereby incorporated by reference.

### TECHNICAL FIELD

This disclosure relates to communication cables and communication cable assemblies.

### BACKGROUND OF THE INVENTION

In recent years, transmission cables that can reduce costs and improve transmission characteristics have been proposed (see, for example, Patent Literature 1).

The USB (Universal Serial Bus) standard, one of the interface standards, has been developed in various ways, and the maximum transfer rate has been improved. For example, USB 1.0 and USB 1.1 have a maximum transfer rate of 12 Mbps. USB2.0 has a maximum transfer rate of 480 Mbps, USB3.0 has a maximum transfer rate of 5 Gbps, and USB3.1 has a maximum transfer rate of 10 Gbps, and USB3.2 has a maximum transfer rate of 20 Gbps. On the other hand, for connectors, Type-A and Type-B connectors have been specified, but Type-C, which has a reversible connector, is specified for USB 3.1 and later.

In addition, USB cables have become capable of various types of communication with a single cable. This has led to an increase in the complexity of the core wire configuration and the number of cores. For example, it is recommended that USB 2.0 has four cores, USB 3.0 has eight cores, and USB Type-C has fifteen cores.

The transmission cable described in Patent Literature 1 is a transmission cable compliant with the USB Type-C standard. This transmission cable is a 17-core cable that includes eight coaxial wires (for 10 Gbps transmission), four signal wires (a first SBU wire, a second SBU wire, a configuration channel (CC) wire, and a Vconn wire), one power wire, two ground wires, and a pair of twisted pair wires.
Citation List Patent Literature 1: JP2017-10747A

### SUMMARY OF THE INVENTION

Conventional transmission cables compliant with the USB Type-C standard are mainstream in many countries as charging cables for smartphones. In addition, there is a movement to adopt the USB Type-C standard as power cables and communication cables not only for smartphones but also for PCs, other communication devices, and imaging devices. This is thought not to standardize cable characteristics but to unify connector plugs (mating parts) and receptacles of devices to be connected to increase convenience. On the other hand, the USB Type-C standard defines specifications for both the cable and the connector. The cable outer diameter (cable diameter) is also limited due to the size of the USB Type-C standard-compliant connector board. Therefore, the conductor cross-sectional area of each core wire cannot be increased, and the communication quality deteriorates when the cable length is long.

Therefore, an object of the present invention is to provide a communication cable and communication cable assembly that can be used with reversible plugs that can be inserted into a receptacle even when the front and back sides of the plug are reversed, and that can achieve longer communication distance (i.e. communication range) relative to the cable diameter.

For solving the above problem, the first aspect provides a communication cable, comprising two first differential pair wires for transmitting high-speed differential signals; a second differential pair wire for transmitting low-speed differential signals; a power wire; a ground wire; and a configuration channel wire for detecting front and back orientation of a plug, wherein the communication cable is devoid of other first differential pair wires than the two first differential pair wires.

The second aspect provides the communication cable further comprising a power wire for a circuit in the plug.

The third aspect provides the communication cable, wherein signal wires constituting each of the first differential pair wires have a conductor at a center and an insulation layer covering the conductor, and wherein a ratio of a conductor diameter of the conductor to a cable diameter is 0.06 or more and 0.07 or less.

The fourth aspect provides the communication cable according to the third aspect, wherein a ratio of a communication distance of the high-speed differential signals to the cable diameter is 800 or more.

The fifth aspect provides the communication cable, wherein a number of core wires is 9 or more and 14 or less.

The sixth aspect provides a communication cable assembly, comprising the communication cable according to the first aspect, wherein the plug comprises a pair of plugs electrically connected to both terminals of the communication cable.

### Advantageous Effects of the Invention

The first and fifth aspects of the invention enable the use of a reversible plug that can be plugged into a receptacle even when the front and back are reversed, thereby extending the communication distance relative to the cable diameter.

The second aspect of the invention enables high-speed charging of devices by using an IC chip (eMarker) as a circuit in the plug.

The third and fourth aspects can increase the communication distance if the cable diameter is the same as that of the conventional cable.

### BRIEF DESCRIPTION OF DRAWINGS

FIGS. 1A and 1B are plan views showing examples of a communication cable assembly according to the first embodiment.

FIG. 1C is a side view of a mating part and pins of a plug of the communication cable assembly according to the first embodiment.

FIG. 2 is a cross-sectional view of an example of the communication cable shown in FIG. 1.

FIGS. 3A and 3B show a connector board corresponding to cables compliant with the USB Type-C standard. FIG. 3A shows a plan view of the connector board viewed from the front side, and FIG. 3B shows a plan view of the connector board viewed from the back side.

FIGS. 4A and 4B show an example of a connector board in the first embodiment, wherein FIG. 4A is a plan view of the connector board viewed from the front side, and FIG. 4B is a plan view of the connector board viewed from the back side.

FIGS. 5A and 5B show the connection of the first differential pair wire to the connector board shown in FIGS. 4A and 4B, wherein FIG. 5A is a plan view of the connector board viewed from the front side and FIG. 5B is a plan view of the connector board viewed from the back side.

FIG. 6 is a cross-sectional view of an example of a communication cable in the second embodiment.

FIG. 7 is a cross-sectional view of an example of a communication cable in the third embodiment.

FIG. 8 is a cross-sectional view showing an example of a communication cable in the fourth embodiment.

FIGS. 9A and 9 B show the connection of the first differential pair wire to the connector board shown in FIGS. 4A and 4B, wherein FIG. 9A is a plan view of the connector board viewed from the front side and FIG. 9B is a plan view of the connector board viewed from the back side.

FIG. 10 is a cross-sectional view of a communication cable in the fifth embodiment.

FIG. 11A is a graph showing the attenuation characteristics when the cable length is 3 m.

FIG. 11B is a graph showing the attenuation characteristics of the cable lengths corresponding to the respective communication distances.

FIGS. 12A and 12B are diagrams schematically showing examples of core wire arrangement.

FIGS. 12C to 12E are diagrams schematically showing examples of core wire arrangement.

FIGS. 12F to 12K are diagrams schematically showing examples of core wire arrangement.

FIGS. 12L to 12Q are diagrams schematically showing examples of core wire arrangement.

### DETAILED DESCRIPTION OF THE INVENTION

### Embodiments

Next, the embodiments will be described with reference to the appended drawings. In each of the figures, the same symbols are used for components that have substantially the same functions in the figures, and redundant descriptions are omitted.

### First Embodiment

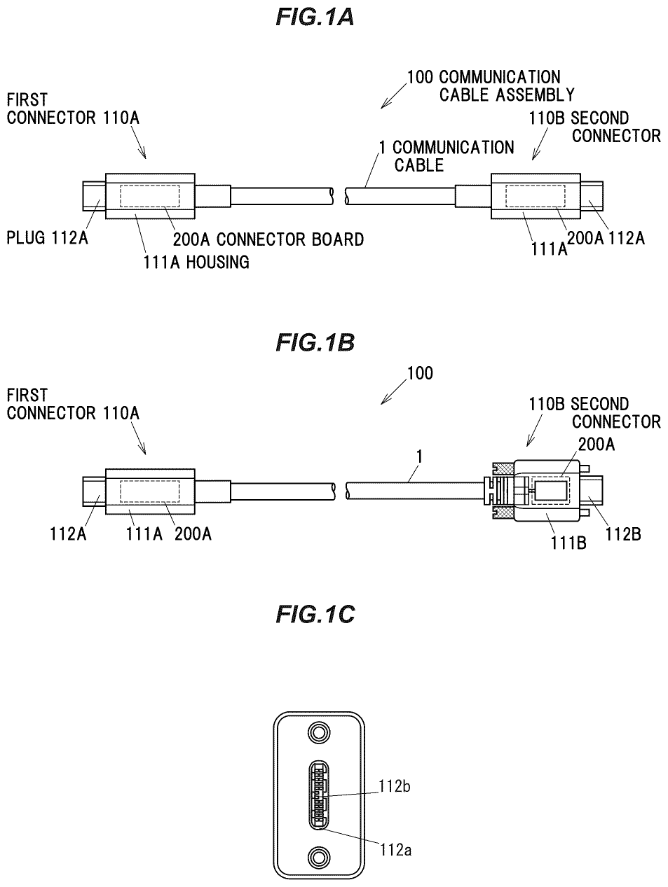

FIGS. 1A and 1B are plan views showing examples of a communication cable assembly according to the first embodiment. This communication cable assembly 100 comprises a communication cable 1 of a predetermined length within a communication distance, a first plug (hereinafter abbreviated as “first connector”) 110A, which is connected to one end of the communication cable 1, and a second plug (hereinafter abbreviated as “second connector”) 110B, which is connected to the other end of the communication cable 1. FIG. 1C is a side view of a mating part 112a and pins 112b of a plug 112A or 112B.

The communication cable 1 is a 9-core cable with a reduced number of cores compared to the core wire configuration of a cable compliant with the USB Type-C standard. In other words, a cable compliant with the USB Type-C standard has four pairs of high-frequency signal wires (SSTX1 wire, SSRX1 wire, SSTX2 wire, and SSRX2 wire), but this communication cable 1 has only two pairs of high-frequency signal wires (e.g., SSTX1 wire, SSRX1 wire).

In addition, a conventional cable compliant with the USB Type-C standard includes the signal wires (SBU1 wire, SBU2 wire) for the alternate mode (HDM (registered trademark) DisplayPort, etc.). However, this communication cable 1 has no alternate mode. In other words, this communication cable 1 does not include the signal wires (SBU1 and SBU2 wires), or it is specialized for USB signals. The signal wires (SBU1 and SBU2) may be added as necessary.

The above configuration reduces the number of core wires, and when the cable diameter is the same as the conventional cable compliant with the USB Type-C standard, the conductor diameters of the SSTX1 and SSRX1 wires can be increased, thereby extending the communication distance. In other words, the communication distance can be increased in relation to the cable diameter. In addition, the USB Type-C compliant CC wires can be left as they are, which allows the USB Type-C compliant CC wires to be connected to a USB Type-C compliant connector, i.e., a reversible plug that can be plugged into a receptacle even when the front and back (top and bottom) are reversed. In addition, the number of core wires can be reduced, which allows the core wires to be thicker, which has advantages in the selection of resin layer materials and manufacturing, as described below. In order to enjoy the convenience of the unification of connectors compliant with the USB Type-C standard, the shape and structure of the mating part of the connector should at least be consistent with the shape and structure of the mating part of the USB Type-C standard of the device to be connected. The shape and structure of the connector board and cable other than the mating part of the connector need not conform to the USB Type-C standard. In other words, the terminals of the communication cable 1 are electrically connected to the pins 112b in the plug 112A or the plug 112B. While the plug 112A, 112B includes a mating part 112a and the pins 112b having a shape and configuration compliant with USB Type-C standard, the number of pins 112b in the plug 112A, 112B that are electrically connected to the communication cable 1 is less than the number of pins compliant with the USB type-C standard. Namely, the number of terminals of the communication cable 1 that are electrically connected to the pins 112b is less than the number of pins in the plug compliant with the USB type-C standard. In addition, since the cable length can be increased without degrading communication quality and the cable can be made lighter, it can be used for in-vehicle equipment, for example.

The first connector 110A is connected to, e.g., a receptacle in a computer and has a resin housing 111A, a plug 112A exposed from the housing 111A, and a connector board 200 located in the housing 111A. The connector board 200A of the first connector 110A electrically connects the plug 112A to one terminal of the communication cable 1.

The second connector 110B is connected to, e.g., a receptacle provided in a peripheral device and uses the same connector as the first connector 110A, as shown in FIG. 1A. In other words, the second connector 110B has a housing 111A made of resin, a plug 112A exposed from the housing 111A, and a connector board 200A located in the housing 111A. The connector board 200A of the second connector 110B electrically connects the plug 112A to the other end of the communication cable 1.

As shown in FIG. 1A, the first connector 110A and the second connector 110B use the same connector, but as shown in FIG. 1B, different connectors may be used. For example, the second connector 110B has a housing 111B made of resin and having a screw to prevent connector disconnection, a plug 112B exposed from the housing 111B, and a connector board 200A located in the housing 111B. In the present embodiment, the connector board 200A of the first connector 110A and the connector board 200A of the second connector 110B use the same board, but they may use different boards from each other.

### (Configuration of Communication Cable)

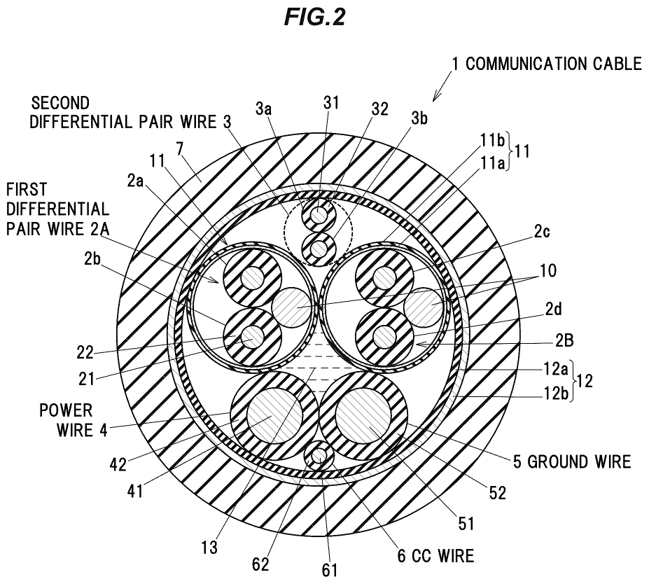

FIG. 2 is a cross-sectional view of the communication cable 1 shown in FIGS. 1A and 1B. This communication cable 1 includes two first differential pair wires 2A and 2B that transmit high-speed differential signals (e.g., 5 Gbps to 20 Gbps), a second differential pair wire 3 that transmits low-speed differential signals (e.g., 480 Mbps), a power wire 4 (Vbus wire), a ground wire 5, a configuration channel wire (hereinafter referred to as the “CC wire”) 6 for detecting the front and back orientation of the plug according to the USB Type-C standard, and is a 9-core cable having no other differential pair wires than the two first differential pair wires 2A and 2B, as the first differential pair wire. In other words, the communication cable 1 is devoid of other first differential pair wires than the two first differential pair wires 2A and 2B. The communication cable 1 is not limited to a 9-core cable, but may be a cable with 10 or more cores or 14 or less cores. 14 or less cores can be used to differentiate it from the recommended number of cores in the USB Type-C standard (15-cores). In addition, the CC wire 6 may not conform to the USB Type-C standard.

Of the signal wires 2a to 2d that constitute the first differential pair wires 2A and 2B, the two adjacent signal wires 2a and 2b constitute a first differential pair, and the other two adjacent signal wires 2c and 2d constitute a second differential pair. The pair of signal wires 2a and 2b are twisted together with the drain wire 10 and covered collectively by the shield layer 11, thus constituting the first Twinax cable. The other pair of signal wires 2a and 2b are also twisted together with the drain wire 10 and covered collectively by the shield layer 11, thus constituting the second Twinax Cable. The communication cable 1 using a Twinax cable for the first differential pair wires 2A and 2B is hereinafter also referred to as a Twinax type communication cable. A non-twisted type of Twinax cable may also be used as a Twinax cable. The drain wire 10 is, for example, a stranded wire made by twisting together a plurality of metal strands. The signal wires 2a to 2d are examples of signal wires constituting the first differential pair wire.

Each of the signal wires 2a to 2d has a conductor 21 and an insulation layer 22 that covers the conductor 21. The conductor 21 is, for example, a stranded wire consisting of a plurality of metal strands twisted together. The insulation layer 22 is formed from a resin material (e.g., cross-linked polyethylene). The conductor 21 is an example of a center conductor.

The shield layer 11 is provided with an inner shield layer 11a, which is provided inside and formed by wrapping electrically conductive tape (e.g., tape laminated with aluminum and polyester), and an outer shield layer 11b, which is provided outside the inner shield layer 11a and formed by wrapping resin tape (e.g., polyester tape).

A second differential pair wire 3 consists of two signal wires 3a and 3b twisted together. Each of the signal wires 3a and 3b has a conductor 31 and an insulation layer 32 that covers the conductor 31. The conductor 31 is, for example, a stranded wire made by twisting together a plurality of metal strands. The insulation layer 32 is formed from a resin material (e.g., cross-linked polyethylene).

The power wire 4 has a conductor 41 and an insulation layer 42 that covers the conductor 41. The conductor 41 is, for example, a stranded wire consisting of a plurality of metal strands twisted together. The insulation layer 42 is formed from a resin material (e.g., cross-linked polyethylene).

The ground wire 5 has a conductor 51 and an insulation layer 52 that covers the conductor 51. The conductor 51 is, for example, a stranded wire consisting of a plurality of metal strands twisted together. The insulation layer 52 is formed from a resin material (e.g., cross-linked polyethylene). The ground wire 5 may be a bare wire without an insulation layer on its periphery.

The CC wire 6 has a conductor 61 and an insulation layer 52 that covers the conductor 61. The conductor 61 is, for example, a stranded wire consisting of a plurality of metal strands twisted together. The insulation layer 62 is formed from a resin material (e.g., polyvinyl chloride).

The first differential pair wires 2A, 2B, the second differential pair wire 3, the power wire 4, the ground wire 5, and the CC wire 6 are covered by the shield layer 12 together with the filler string 13, and the outside of the shield layer 12 is covered by a sheath 7. The sheath 7 is formed from a resin material (e.g., polyvinyl chloride) with a thickness of about 0.6 to 0.9 mm. The filler string 13 is formed from a fibrous material (e.g., cotton, silk, etc.). The filler string 13 is an example of a filler material.

The shield layer 12 is provided with an inner shield layer 12a, which is provided inside and formed by wrapping electrically conductive tape (e.g., tape laminated with aluminum and polyester), and an outer shield layer 12b, which is provided outside the inner shield layer 12a and formed from metal braid (e.g., tin-plated soft copper wire braid).

### (Connector Board Configuration)

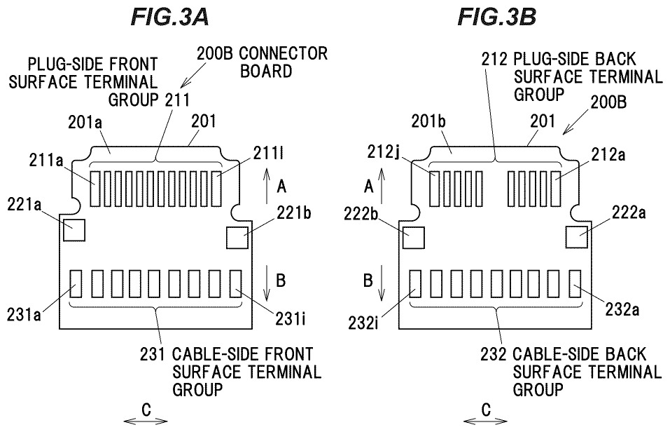

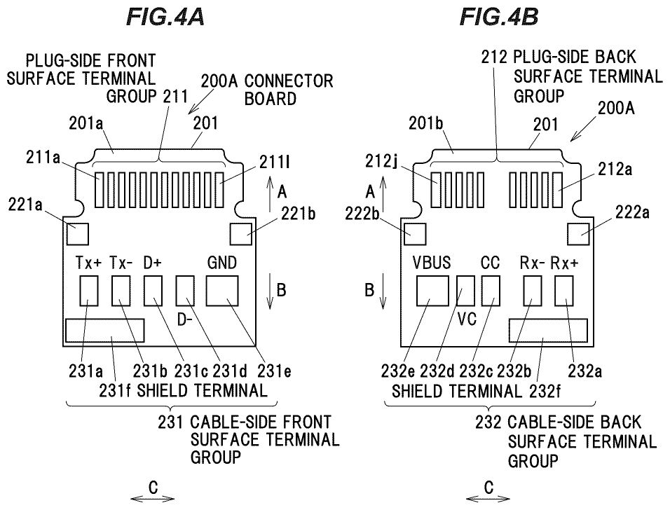

FIGS. 3A and 3B show a connector board 200B corresponding to cables compliant with the USB Type-C standard, FIG. 3A is a plan view of the connector board 200B viewed from the front side, and FIG. 3B is a plan view of the connector board 200B viewed from the back side. FIGS. 4A and 4B show an example of connector board 200A in the present embodiment. FIG. 4A is a plan view of the connector board 200A viewed from the front side, and FIG. 4B is a plan view of the connector board 200A viewed from the back side. In FIGS. 3A, 3B, 4A, and 4B, A indicates the plug-side, B indicates the cable-side, and C indicates the width direction of the connector board.

(Connector Board Configuration Corresponding to Cables Compliant with USB Type-C Standard)

As shown in FIGS. 3A and 3B, the connector board 200B, which is compatible with cables conforming to the USB Type-C standard, has a configuration that can accommodate an 18-core cable, i.e., the number of terminals (also called “pads”) is 18 and has a substrate 201 formed from electrically insulating material.

As shown in FIG. 3A, a front surface 201a of the substrate 201 is formed with a plug-side front surface terminal group 211 consisting of terminals 211a to 2111 provided on the plug-side A, terminals 221a and 221b provided in the middle between the plug-side A and cable-side B, and a cable-side front surface terminal group 231 consisting of terminals 231a to 231i provided on the cable-side B.

As shown in FIG. 3B, a back surface 201b of the substrate 201 is formed with a plug-side back surface terminal group 212 consisting of terminals 212a to 212j provided on the plug-side A, terminals 222a and 222b provided in the middle between the plug-side A and cable-side B, and a cable-side back surface terminal group 232 consisting of terminals 232a to 232i provided on the cable-side B.

The terminals 231a to 231i of the cable-side front surface terminal group 231 are formed with a pitch of 0.9 to 1.0 mm, and the terminals 232a to 232i of the cable-side back surface terminal group 232 are formed with a pitch of 0.9 to 1.0 mm. In other words, the minimum pitch of the terminals in the width direction C of the connector board 200B is 0.9 mm.

### (Configuration of the Connector Board in the Present Embodiment)

A connector board 200A is compliant with the USB Type-C standard, but as shown in FIGS. 4A and 4B, it has a configuration that is compatible with 9-core and 10-core cables, i.e., the number of terminals (also called “pads”) is 10, and has a substrate 201 formed from electrically insulating material.

As shown in FIG. 4A, a front surface 201a of the substrate 201 is formed with a plug-side front surface terminal group 211 consisting of terminals 211a to 2111 provided on the plug-side A, terminals 221a and 221b provided in the middle between the plug-side A and the cable-side B for a metal cover (not shown) on a plug 112A, and a cable-side front surface terminal group 231 consisting of terminals 231a to 231f provided on the cable-side B. Among the cable-side front surface terminal group 231, the terminal 231f is a shield terminal and has a rectangular shape with a longitudinal direction being the width direction C of the connector board 200A. The terminals 231a and 231b of the cable-side front surface terminal group 231 are examples of a pair of front surface terminals. The shield terminal 231f is an example of a front surface shield terminal.

As shown in FIG. 4B, a back surface 201b of the substrate 201 is formed with a plug-side back surface terminal group 212 consisting of terminals 212a to 212j provided on the plug-side A, terminals 222a and 222b provided in the middle between the plug-side A and the cable-side B for a metal cover (not shown) on the plug 112A, and a cable-side back surface terminal group 232 consisting of terminals 232a to 232f provided on the cable-side B. Among the cable-side back surface terminal group 232, the terminal 232f is a shield terminal and has a rectangular shape with a longitudinal direction being the width direction C of the connector board 200A. The front surface 201a and the back surface 201b are examples of one surface. The terminals 232a and 232b of the cable-side back surface terminal group 232 are examples of a pair of back surface terminals. The shield terminal 232f is an example of a back surface shield terminal.

The terminals 231a to 231e, excluding the shield terminal 231f, of the cable-side front surface terminal group 231 are formed with a pitch of 1.0 to 1.57 mm, and the terminals 232a to 232e, excluding the shield terminal 232f, of the cable-side back surface terminal group 232 are formed with a pitch of 1.2 to 2.0 mm. In other words, the minimum pitch of the terminals in the width direction C of the connector board 200A is 1.2 mm.

According to this connector board 200A, the minimum pitch of terminals in the width direction C can be increased to 1.3 times or more than the minimum pitch in the width direction C of the connector board 200B, compliant with the USB Type-C standard. In addition, since the number of cable cores has been reduced, the number of pads on the connector board 200A can also be reduced, and the pad width can be increased from 0.5 mm to 0.8 mm, for example, for the same dimensions and area as the connector board 200B compliant with the USB Type-C standard. The above configuration enables connection work to be performed with the naked eye. In addition, the work of connecting the communication cable 1 to the connector board 200A can be performed without using a jig (alignment component) that aligns and holds the terminals in the communication cable 1 to be connected.

### (Method of Manufacturing a Communication Cable Assembly)

Next, an example of the manufacturing method of a communication cable assembly 100 will be described.

First, two first differential pair wires 2A, 2B, a second differential pair wire 3, a power wire 4, a ground wire 5, a CC wire 6, and a filler 13 are prepared. For the first differential pair wires 2A and 2B, two signal wires 2a, 2b or signal wires 2c, 2d and a drain wire 10, respectively, are twisted together while conductive tape is wrapped around the outer circumference to form an inner shield layer 11a and resin tape is wrapped around the outer circumference of the inner shield layer 11a to form an outer shield layer 11b. The second differential pair wire 3 is formed by twisting two signal wires 3a and 3b together.

Next, the two prepared first differential pair wires 2A, 2B, the second differential pair wire 3, the power wire 4, the ground wire 5, the CC wire 6, and the filler 13 are twisted together and conductive tape is wrapped around the outer circumference of these wires to form the inner shield layer 12a, and metal braid is wrapped around the outer circumference of the inner shield layer 12a to form the outer shield layer 12b. Next, a sheath 7 is formed around the outer circumference of the shield layer 12 by extrusion using an extruder.

The communication cable 1 is manufactured in the manner described above. The communication cable 1 is then cut to the required length, and the terminals are connected to the connector board 100A of the first connector 110A and the connector board 100A of the second connector 110B, thereby producing a communication cable assembly 100 including the communication cable 1, and the first connector 110A and the second connector 110B at both ends of the communication cable 1. The work of connecting the first differential pair wires 2A and 2B to the connector board 100A is described below.

### (Connection Work of the First Differential Pair Wires)

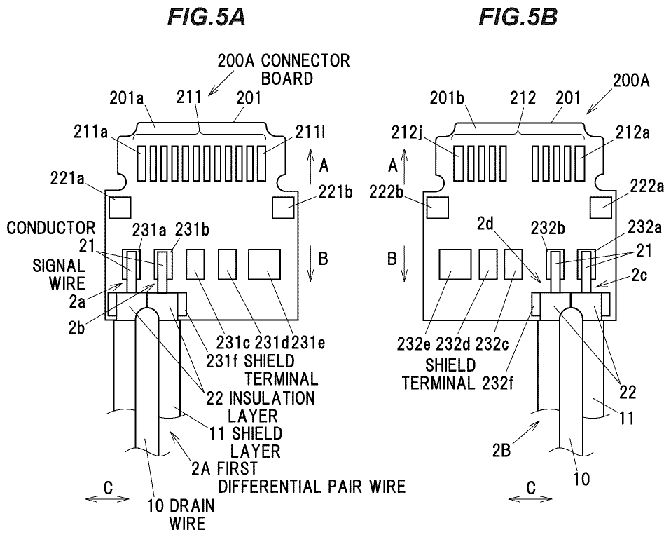

FIGS. 5A and 5B show the connection of the signal wires 2a to 2d of the first differential pair wires 2A and 2B to the connector board 100A shown in FIGS. 4A and 4B, in which FIG. 5A is a plan view of the connector board 100A viewed from the front side and FIG. 5B is a plan view of the connector board 100A viewed from the back side.

When connecting the conductors 21 of the signal wires 2a and 2b of the communication cable 1 of the first embodiment to the terminals 231a and 231b of the cable-side front surface terminal group 231 of the connector board 200B corresponding to the cable compliant with the USB Type-C standard shown in FIG. 3A, the shield layer 11 must be peeled off, and then the insulation layers 22 of the signal wires 2a and 2b must be peeled off, and the exposed conductors 21 must be connected to the terminals 231a and 231b with a narrow pitch. On the other hand, when connecting the conductors 21 of the signal wires 2a and 2b to the terminals 231a and 231b of the cable-side front surface terminal group 231 of the connector board 200A shown in FIG. 4A, the terminals 231a and 231b have a wide pitch, making the work of connecting the signal wires 2a and 2b easier. This is also applicable for the back surface 201b of the connector board 200a shown in FIG. 4B. The drain wire 10 is pulled out from the shield layer 11 and connected to the metal cover (not shown) of the plug 112A.

### Effects of the First Embodiment

According to the first embodiment of the communication cable assembly 100, the following effects are achieved.

(a) The number of cores can be reduced compared to the core wire configuration of cables compliant with the USB Type-C standard, which reduces manufacturing costs and lightens the weight.

(b) When the cable outer diameters are the same, the outer diameter of the core wire can be increased, which enables various characteristics (communication performance, bending resistance (refers to the characteristics of resistance to wire breakage when the cable is repeatedly bent. The same applies hereafter), and mechanical strength). In addition, the thicker conductor reduces the risk of wire breakage due to injection pressure during molding, thereby expanding the options for molding methods. Further, when the cable outer diameters are the same, the core wires such as signal wires 2a and 2b can be made thicker, which expands the range of selection of materials for the insulation layer, for example, from expensive nylon resins such as polyamide to inexpensive polyolefin resins such as polyethylene. It is also possible to shorten the molding time by changing the molding machine from a dedicated low-pressure molding machine to a general-purpose molding machine that performs injection molding.

(c) Since the communication distance of high-speed differential signals relative to the cable diameter can be increased when the cable diameter is reduced (e.g., 3.7 mm), the communication cable can be made lighter without reducing the communication distance. When the cable diameter is the same as before (e.g., 6.8 mm), the communication distance can be increased because the conductors 21 of the first differential pair wires 2A and 2B can be made thicker.

(d) The CC wire 6 allows the use of a reversible plug that can be plugged in even when the front and back (top and bottom) are reversed with respect to the receptacle.

(e) The pitch of terminals 231a and 231b and the pitch of terminals 232a and 232b of connector board 200A are wide, which makes it easy to connect the signal wires 2a to 2d, which constitute the first differential pair wires 2A and 2B, to the connector board 200A.

### The Second Embodiment

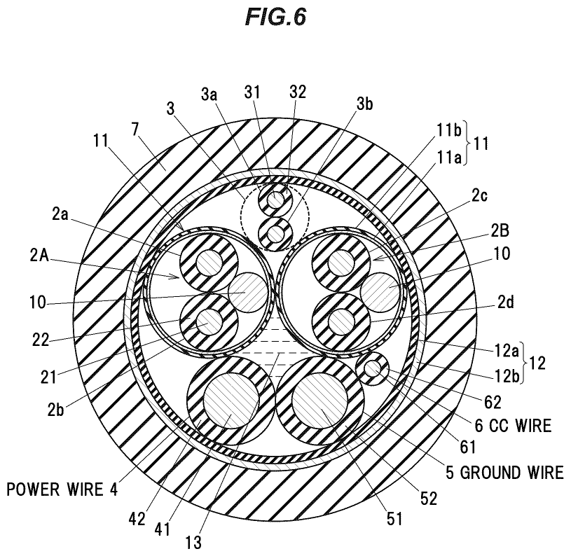

FIG. 6 is a cross-sectional view of a communication cable of the second embodiment. In the communication cable 1 of the first embodiment, the CC wire 6 was placed between the power wire 4 and the ground wire 5. In the communication cable 1 of the present embodiment, the CC wire 6 is placed at the position where it contacts the shield layer 11 covering the first differential pair wire 2B and the ground wire 5, thereby reducing the conductor diameter of the conductors 21 of the signal wires 2a to 2d to reduce the cable diameter. Since the communication cable assembly 100 of the second embodiment is manufactured in the same way as the first embodiment, its description is omitted.

According to the second embodiment, by selecting the outer diameters of the power wire 4, ground wire 5, and CC wire 6 as appropriate, the cable outer diameter can be made smaller than in the first embodiment without shortening the communication distance for high-speed differential signals.

### The Third Embodiment

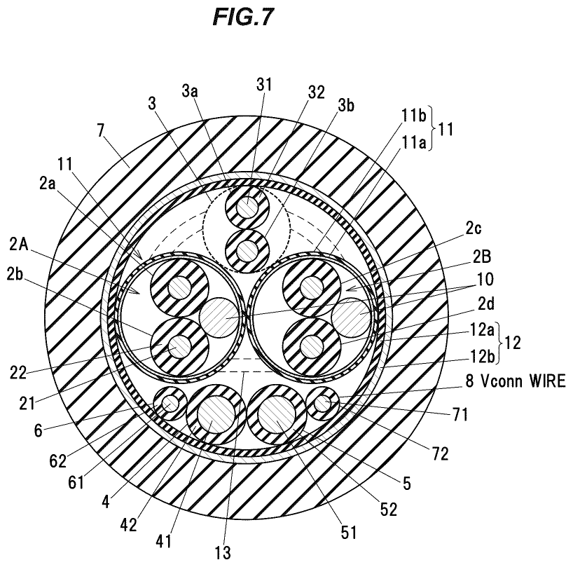

FIG. 7 is a cross-sectional view of a communication cable of the third embodiment. The communication cable 1 of the first embodiment is a 9-core cable, but the communication cable 1 of the present embodiment is a 10-core cable by adding a power wire for circuits in the plug (hereinafter referred to as “Vconn wire”) conforming to the USB Type-C standard to the communication cable 1 of the first embodiment. The following explanation focuses on the points that differ from the first embodiment.

Similarly to the first embodiment, the communication cable 1 of the third embodiment is a 10-core cable including two first differential pair wires 2A and 2B, a second differential pair wire 3, a power wire 4, a ground wire 5, and a CC wire 6 compliant with the USB Type-C standard, as well as a Vconn wire 8. The communication cable 1 is not limited to a 10-core cable but may have 11 or more cores. The Vconn wire 8 may not conform to the USB Type-C standard.

The Vconn wire 8 has a conductor 81 and an insulation layer 82 that covers the conductor 81. The conductor 81 is, for example, a stranded wire consisting of a plurality of metal strands twisted together. The insulation layer 82 is formed from a resin material (e.g., polyvinyl chloride).

In the first embodiment, the CC wire 6 is placed between the power wire 4 and the ground wire 5, but in the present embodiment, the CC wire 6 is placed alongside the power wire 4 and the ground wire 5, with the CC wire 6 on one side of them and the Vconn wire 8 on the other side. The CC wire 6 and the Vconn wire 8 are connected to the plug's built-in IC chip (eMarker). The communication cable assembly 100 of the third embodiment is manufactured in the same way as the first embodiment, so its description is omitted.

According to the third embodiment, the same effect as the first embodiment is achieved, and since the CC wire 6 and the Vconn wire 8 are provided, the charger and the device can be connected with the communication cable 1 to enable high-speed charging of the device with a power corresponding to the USB PD (Power Delivery) standard.

### The Fourth Embodiment

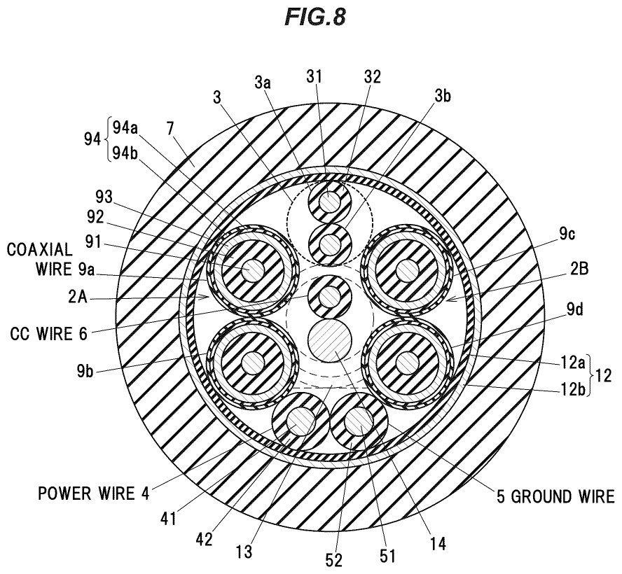

FIG. 8 is a cross-sectional view of an example of a communication cable of the fourth embodiment of the invention. In the communication cable 1 of the first embodiment, the first differential pair wire of signal wires 2a and 2b and the second differential pair wire of signal wires 2c and 2d, which constitute the two first differential pair wires 2A and 2B, respectively, are collectively shielded by the shield layer 11. The communication cable 1 of the present embodiment is a cable using coaxial wires (coaxial cables) 9a to 9d as the signal wires that constitute the two first differential pair wires 2A and 2B (also called “Coaxial type communication cable”). The following explanation focuses on the points that differ from the first embodiment.

In the communication cable 1 of the fourth embodiment, a first differential pair wire 2A is composed of a first differential pair wire of coaxial wires 9a and 9b, a first differential pair wire 2B is composed of a second differential pair wire of coaxial wires 9c and 9d, these coaxial wires 9a to 9d are arranged on the outer circumference, and a CC wire 6 and a filler string 14 are arranged in the center, the first differential pair wires 2A, 2B, a second differential pair wire 3, a power wire 4 and a ground wire 5 are covered by a shield layer 12 together with a filler string 13, and the outside of the shield layer 12 is covered by a sheath 7. The filler string 14 is formed from a resin material (e.g., polyethylene). The coaxial wires 9a to 9d are examples of signal wires constituting the first differential pair wire. The filler string 14 is an example of a filler.

Each of the coaxial wires 9a to 9d has a center conductor 91, an inner insulation layer 92 covering the center conductor 91, an outer conductor 93 formed outside the inner insulation layer 92, and an outer insulation layer 94 covering the outer conductor 93. The center conductor 91 is, for example, a stranded wire formed by twisting together a plurality of metal strands. The inner insulation layer 92 is formed from a resin material (e.g., cross-linked polyethylene). The outer conductor 93 is formed from, for example, a metal braid. The outer insulation layer 94 is formed from a resin material (e.g., polyvinyl chloride). The center conductor 91 is an example of a center conductor.

### (Method of Manufacturing a Communication Cable Assembly)

Next, an example of a manufacturing method for the communication cable assembly 100 of the fourth embodiment will be described.

First, two first differential pair wires 2A, 2B, a second differential pair wire 3, a power wire 4, a ground wire 5, a CC wire 6, and fillers 13 and 14 are prepared. For the first differential pair wires 2A and 2B, four coaxial wires 9a to 9d constituting them are prepared. The second differential pair wire 3 is formed by twisting two signal wires 3a and 3b together.

Next, the two prepared first differential pair wires 2A, 2B, the second differential pair wire 3, the power wire 4, the ground wire 5, the CC wire 6, and the fillers 13, 14 are twisted together, and conductive tape is wrapped around the outer circumference of these wires to form an inner shield layer 12a, and metal braid is wrapped around the outer circumference of the inner shield layer 12a to form an outer shield layer 12b. Next, a sheath 7 is formed around the outer circumference of the shield layer 12 by extrusion molding using an extruder.

The communication cable 1 is manufactured in the manner described above. The communication cable 1 is then cut to the required length and the terminals are connected to the connector board 100A of the first connector 110A and the connector board 100A of the second connector 110B, so that a communication cable assembly 100 is produced. The work of connecting the coaxial wires 9a to 9d, which constitute the first differential pair wires 2A and 2B, to the connector board 100A is described below.

### (Connection Work of the First Differential Pair Wire)

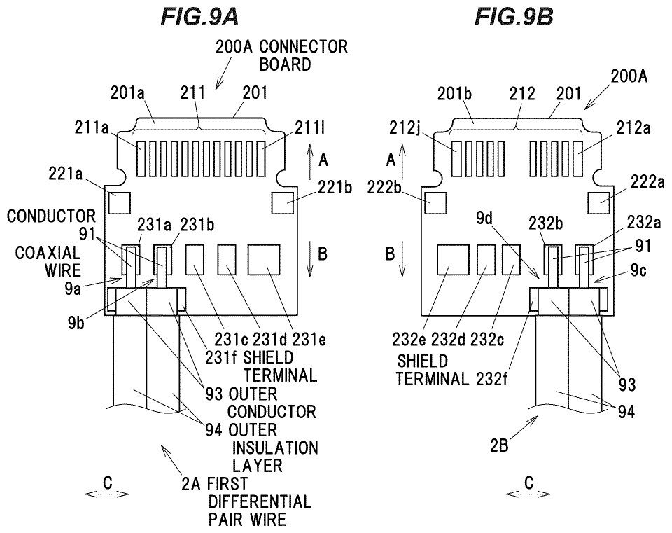

FIGS. 9A and 9B show the connection of the first differential pair wire to the connector board shown in FIGS. 4A and 4B, in which FIG. 9A is a plan view of the connector board viewed from the front side and FIG. 9B is a plan view of the connector board viewed from the back side.

When connecting the center conductors 91 of the coaxial wires 9a and 9b of the communication cable 1 of the fourth embodiment to the terminals 231a and 231b of the cable-side front surface terminal group 231 of the connector board 200B corresponding to the cable compliant with the USB Type-C standard shown in FIG. 3A, the outer insulation layer 94 must be peeled off, and then the inner insulation layer 92 of the coaxial wires 9a and 9b must be peeled off, and the exposed center conductors 91 must be connected to the terminals 231a and 231b with a narrow pitch. The outer conductor 93 must be pulled out like a single conductor and connected to the shield terminal (the metal cover (not shown) of the plug 112A. On the other hand, when connecting the center conductors 91 of the coaxial wires 9a and 9b to the terminals 231a and 231b of the cable-side front surface terminal group 231 of the connector board 200A shown in FIG. 4A, the terminals 231a and 231b have a wide pitch, making it easy to connect the coaxial wires 9a and 9b. Also, an outer circumference surface can be connected to the shield terminal 231f without having to pull out the exposed outer conductor 93 like a single conductor. This is also applicable for the back surface 201b of the connector board 200A shown in FIG. 4B.

### Effects of the Fourth Embodiment

According to the communication cable 1 of the fourth embodiment, the same effects as the first embodiment are achieved, and since the coaxial wires 9a to 9d are used as signal wires constituting the first differential pair wires 2A and 2B, the outer conductors 93 exposed by peeling off the outer insulation layer 94 of the coaxial wires 9a to 9d can be connected to the shield terminals 231f and 232f, making it easy to connect the coaxial wires 9a to 9d to the connector board 200A.

In addition, since the coaxial wires (coaxial cables) 9a to 9d are used as the first differential pair wire 2A, 2B, the coaxial wires 9a to 9d are independent from each other, so that the characteristic change in differential is very small, compared to the Twinax type communication cable, bending resistance can be improved. This is evident from the results of the following durability tests. Namely, an 8-core Coaxial type communication cable without the CC wire 6 was attached to a cable bear (registered trademark), and a durability test was conducted to perform moving bending of the cable under specified conditions repeatedly (moving distance: 1 m, bending speed: 30 times/minute, bending radius (inside): 75 mm). The results of the durability test showed that the required characteristics were maintained even after 30,000,000 cycles of bending by movement, although there was some damage to the sheath and some effects on transmission characteristics. On the other hand, in the Twinax-type communication cable with the same 8-core core wire configuration, when the moving bending exceeds 100,000 times, mechanical damage causes changes in transmission characteristics in the first differential pair wires 2A and 2B, resulting in communication degradation.

### The Fifth Embodiment

FIG. 10 is a cross-sectional view of a communication cable of the fifth embodiment. The communication cable 1 of the present embodiment is made by adding a Vconn wire 8 in the center to the communication cable 1 of the fourth embodiment and using two filler strings 14a and 14b formed from a resin material (e.g., polyethylene). The filler strings 14a and 14b are examples of filler. Since the communication cable assembly 100 of the fifth embodiment is manufactured similarly to the fourth embodiment, the description is omitted.

According to the communication cable 1 of the fifth embodiment, the same effects as the fourth embodiment are achieved, and since it is equipped with the CC wire 6 and the Vconn wire 8, it is possible to connect a charger and a device with the communication cable 1 and charge the device at high speed with a power corresponding to the USB PD (Power Delivery) standard. In addition, since the coaxial wires 9a to 9d are employed as the first differential pair wires 2A and 2B, bending resistance can be improved.

### Examples

The communication performance (communication range and attenuation characteristics) of Example 1 corresponding to the first embodiment, Example 2 corresponding to the second embodiment, and a comparative example were tested and evaluated as described below.

### (Test Conditions for Communication Range)

A personal computer (PC) as a computer and a camera as a peripheral device were connected by the communication cable under test. The PC was a ProBook 430 G5 available from HP Inc., and the camera was a USB 3.1 Gen1 uEye SE series available from IDS Imaging Development Systems GmbH. The communication cables under test were the following examples: Example 1, Example 2, and Comparative Example. Their configurations are shown in Table 1. In Table 1, T indicates tin-plated soft copper wire and AG indicates silver-plated soft copper wire. In the comparative example, only wires that can be compared with Examples 1 and 2 are shown in Table 1.

TABLE 1

| | | | | | | Comparative |
|---|---|---|---|---|---|---|
| | | | | Example 1 | Example 2 | Example |
| First | Signal | Conductor | AWG size/Outer | 27/0.42 | 32/0.24 | 30/0.30 |
| differential | wire | | diameter (mm) | | | |
| pair wire | | | Twist configuration | 7/0.14T | 7/0.08T | 7/0.102AG |
| | | | (strands/mm) | | | |
| | | insulation | Material | Cross- | Cross- | PFA |
| | | layer | | linked PE | linked PE | |
| | | | Outer diameter (mm) | 1.12 | 0.60 | 0.75 |
| | Drain | Twist configuration | | 7/0.14T | 7/0.08T | 7/0.102T |
| | wire | (strands/mm) | | | | |
| | | Outer diameter (mm) | | 0.42 | 0.24 | 0.30 |
| | Shield | Inner | Material (Tape) | Polyester/ | Polyester/ | Polyester/ |
| | layer | | | Copper | Copper | Aluminum |
| | | | Outer diameter (mm) | 2.3 | 2.3 | 1.56 |
| | | Outer | Material (Tape) | Polyester | Polyester | Polyester |
| | | | Outer diameter (mm) | 2.34 | 2.34 | 1.60 |
| Number of first differential pair wires | | | | 2 | 2 | 4 |
| Second | Signal | Conductor | AWG size/Outer | 28/0.38 | 34/0.19 | 34/0.19 |
| differential | wire | | diameter (mm) | | | |
| pair wire | | | Twist configuration | 7/0.127T | 7/0.064T | 7/0.064T |
| | | | (strands/mm) | | | |
| | | Insulation | Material | PE | PFA | PFA |
| | | layer | Outer diameter (mm) | 0.75 | 0.34 | 0.40 |
| | Shield | Inner | Material (Tape) | — | | Polyester/ |
| | layer | | | | | Aluminum |
| | | | Outer diameter (mm) | — | | 0.84 |
| | | Outer | Material (Tape) | — | | Polyester |
| | | | Outer diameter (mm) | — | | 0.86 |

| Power wire | Conductor | AWG size/Outer | 22/0.76 | 26/0.48 | 26/0.50 |
|---|---|---|---|---|---|
| Ground wire | | diameter (mm) | | | |
| | | Twist configuration | 17/0.16T | 7/0.16T | 19/0.1 |
| | | (strands/mm) | | | |
| | Insulation | Material | Lead-free | Cross- | Cross- |
| | layer | | PVC | linked PE | linked PE |
| | | Outer diameter (mm) | 1.20 | 0.75 | 0.75 |
| CC wire | Conductor | AWG size/Outer | 28/0.38 | 34/0.192 | 34/0.19 |
| | | diameter (mm) | | | |
| | | Twist configuration | 7/0.13T | 7/0.064T | 7/0.064T |
| | | (strands/mm) | | | |
| | Insulation | Material | Lead-free | PFA | Cross- |
| | layer | | PVC | | linked PE |
| | | Outer diameter (mm) | 0.78 | 0.34 | 0.41 |

| Shield layer | Braided | Single, 0.1T | Single | Single |
|---|---|---|---|---|
| | configuration (mm) | | layer, 0.08T | layer, 0.05T |
| | Outer diameter (mm) | 5.05 | 2.56 | 4.18 |
| Sheath | Material | Lead-free | Lead-free | Lead-free |
| | | PVC | PVC | PVC |
| | Thickness (mm) | 0.875/6.8 | 0.57/3.7 | 0.51/5.2 |
| | Outer diameter (mm) | | | |

| | | | |
|---|---|---|---|
| Number of cores | 9 | 9 | 17 |

In Example 1, a 9-core cable with a cable diameter of 6.8 mm was used. A conductor with AWG size 27 (conductor diameter of 0.42 mm) was used as the conductors 21 of the signal wires 2a to 2d, which constitute the first differential pair wire 2A and 2B. A ratio of the conductor diameter d relative to the cable diameter D (d/D) was 0.062.

In Example 2, a 9-core cable with a cable diameter of 3.7 mm was used. A conductor with AWG size 32 (conductor diameter of 0.24 mm) was used as the conductors 21 of the signal wires 2a to 2d constituting the first differential pair wires 2A and 2B. A ratio of the conductor diameter d relative to the cable diameter D (d/D) was 0.065.

In the comparative example, a 17-core cable with a cable diameter of 5.2 mm was used, and a conductor with AWG size 34 (conductor diameter 0.3 mm) was used as the conductors of the signal wires constituting the first differential pair wire. A ratio of the conductor diameter d relative to the cable diameter D (d/D) was 0.058. If the ratio (d/D) exceeds 0.07, the weight of the communication cable increases.

### (Method of Evaluation of Communication Distance)

The images captured by the camera were transmitted to the PC via the communication cable under test, and the communication performance (communication distance) was evaluated based on whether the images were frozen, dropped, noisy, or discolored during the 10 minutes of imaging. 10 minutes with no image problems was designated as “Good” (∘), while no images were captured on the PC was designated as “No good” (x). The evaluation results are shown in Table 2.

### (Attenuation Characteristics)

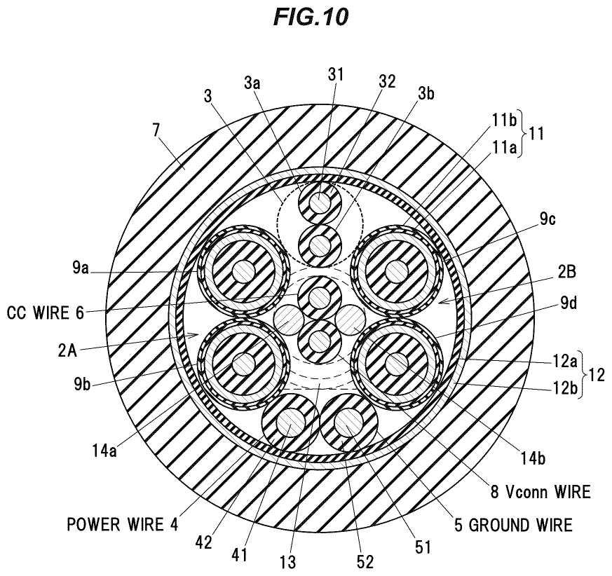

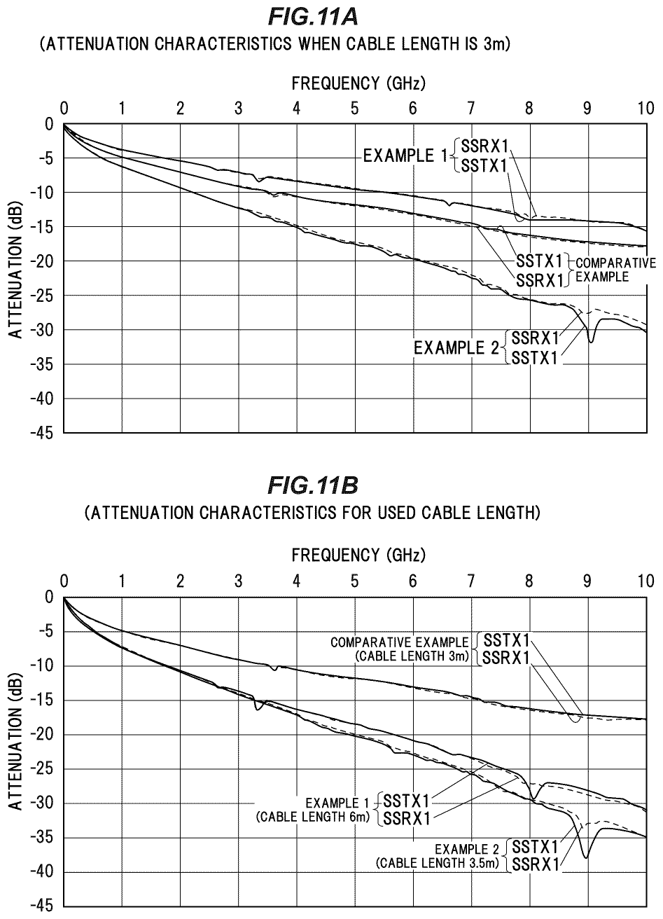

FIG. 11A shows the attenuation characteristics when the cable length is 3 m. FIG. 11B shows the attenuation characteristics according to the cable length (used cable length) corresponding to the respective communication distances. Since the data transmission rate of the camera used is 5 Gbps, the attenuation characteristics around 2.5 GHz were measured.

The attenuation when the length of the communication cable was 3 m was attributed to the AWG size of the communication cable, and as shown in FIG. 11A, the smaller the AWG size (larger conductor diameter), the smaller the attenuation. In other words, the attenuation around the frequency of 2.5 GHz was 6 dB in Example 1, 11 dB in Example 2, and 8 dB in the comparative example. These attenuation values are shown in Table 2.

As shown in FIG. 11B, the attenuation at the cable length corresponding to the respective communication distances is 13 dB around 2.5 GHz in the case of Examples 1 and 2, which can be estimated as the communication limit. On the other hand, in the case of the comparative example, although the attenuation is as low as 8 dB near 2.5 GHZ, the communication distance is 3 m, which is the shortest communication distance, due to the power supply specification using the power wire 4 (Vbus wire), the potential difference with the GND, and other factors. The above attenuation values are shown in Table 2.

TABLE 2

| | Example 1 | | | | Example 2 | | | | Comparative Example | | | |
|---|---|---|---|---|---|---|---|---|---|---|---|---|
| First differential | 0.42 | | | | 0.24 | | | | 0.30 | | | |
| pair wire | | | | | | | | | | | | |
| conductor | | | | | | | | | | | | |
| diameter d (mm) | | | | | | | | | | | | |
| Cable diameter | 6.8 | | | | 3.7 | | | | 5.2 | | | |
| D (mm) | | | | | | | | | | | | |
| d/D | 0.062 | | | | 0.065 | | | | 0.058 | | | |
| Communication | 5.0 | 5.5 | 6.0 | 6.5 | 2.5 | 3.0 | 3.5 | 4.0 | 2.0 | 2.5 | 3.0 | 3.5 |
| distance L(m) | | | | | | | | | | | | |
| Image Evaluation | ∘ | ∘ | ∘ | x | ∘ | ∘ | ∘ | x | ∘ | ∘ | ∘ | x |
| | Good | Good | Good | No | Good | Good | Good | No | Good | Good | Good | No |
| | | | | good | | | | good | | | | good |
| L/D | 882 | | | | 946 | | | | 577 | | | |
| Attenuation | 6 (Cable | | | | 11 (Cable | | | | 8 (Cable | | | |
| around 2.5 | length 3 m) | | | | length 3 m) | | | | length 3 m) | | | |
| GHz (dB) | | | | | | | | | | | | |
| Attenuation | 13 (Cable | | | | 13 (Cable | | | | 8 (Cable | | | |
| around 2.5 | length 6 m) | | | | length 3.5 m) | | | | length 3 m) | | | |
| GHz (dB) | | | | | | | | | | | | |

### Summary of Evaluation

(1) Example 1 (cable diameter of 6.8 mm) doubled the communication distance from 3 m to 6 m compared to the comparative example (cable diameter of 5.2 mm). Example 2 (cable diameter of 3.7 mm) had the same communication performance as the comparative example (cable diameter of 5.2 mm), and the weight of the communication cable could be reduced.

(2) When the cable diameter was D and the communication distance was L, the evaluated values of communication performance were expressed by a ratio of communication distance L to cable diameter D (L/D). L/D=6000 mm/6.8 mm=882 for Example 1, L/D=3500 mm/3.7 mm=946 for Example 2, and L/D=3000 mm/5.2 mm=577 for the comparative example. Therefore, it can be said that the communication distance relative to the cable diameter L/D is preferably 800 or more, or 880 or more, and more preferably 900 or more, or 940 or more.

### (Examples of Core Wire Arrangement)

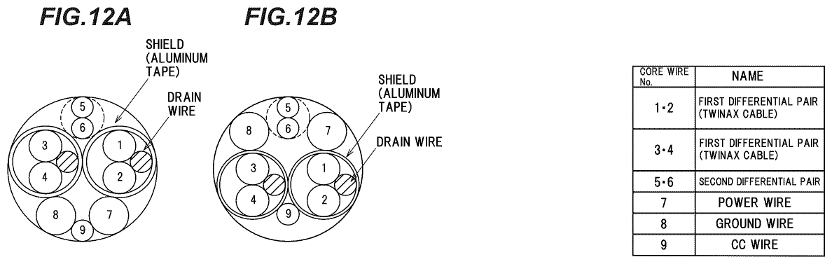

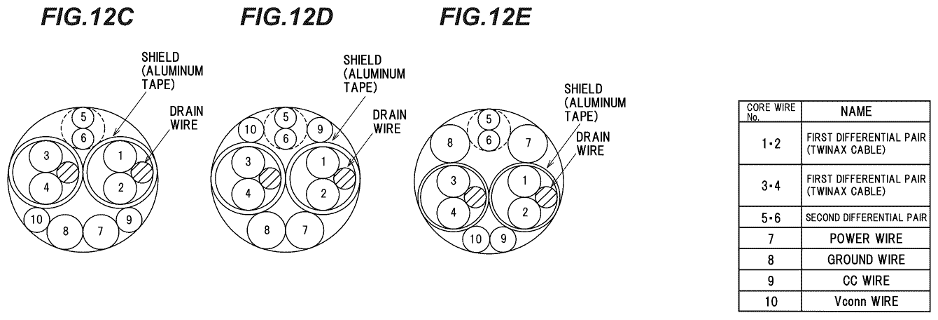

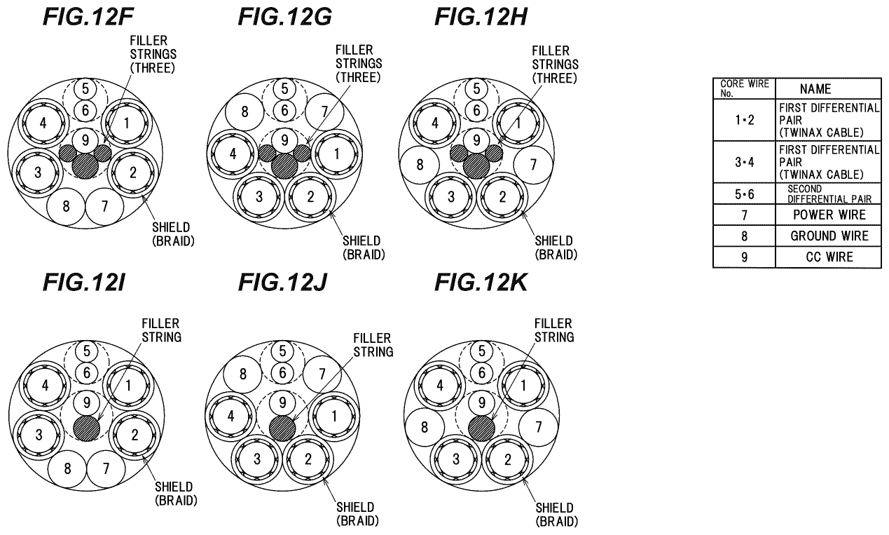

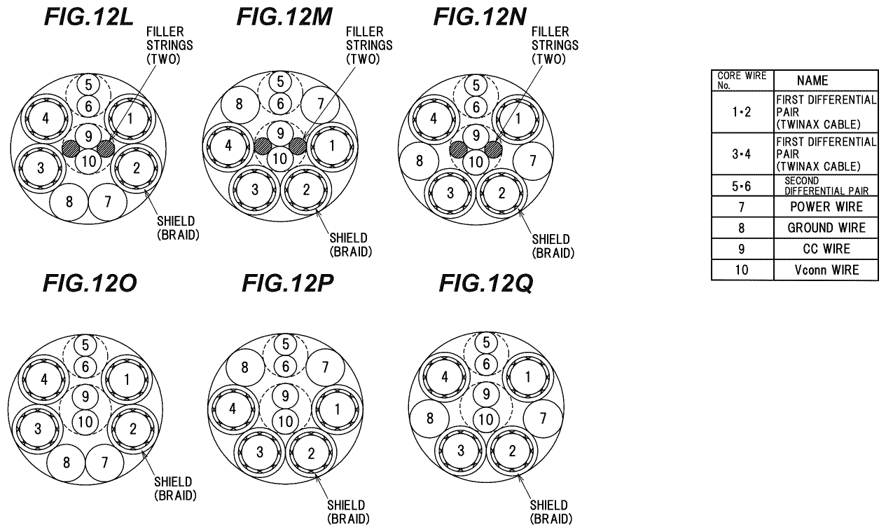

FIGS. 12A to 12Q schematically show examples of layouts of core wires constituting the communication cable 1. FIGS. 12A to 12E show the layout of core wires that do not require high bending resistance, and FIGS. 12F to 12Q show the layout of core wires that require high bending resistance. FIG. 12A corresponds to the first embodiment (FIG. 2), FIG. 12C corresponds to the third embodiment (FIG. 7), FIG. 12I corresponds to the fourth embodiment (FIG. 8), and FIG. 12L corresponds to the fifth embodiment (FIG. 10).

In the 9-core communication cable 1 that employs a Twinax cable for the first differential pair wire 2A, 2B, the power wire (core wire No. 7) and the ground wire (core wire No. 8) are arranged on both sides of the CC wire (core wire No. 9), as shown in FIG. 12A in the first embodiment. It is also possible to place the ground wire and the CC wire on both sides of the second differential pair wire 3 as shown in FIG. 12B.

In the 10-core communication cable 1 that employs a twinax cable for the first differential pair wires 2A and 2B, the CC wire (core wire No. 9) and the Vconn wire (core wire No. 10) are arranged on both sides of the power wire (core wire No. 7) and the ground wire (core wire No. 8) as shown in FIG. 12C in the third embodiment. However, as shown in FIG. 12D, the CC wire and the Vconn wire may be placed on both sides of the second differential pair wire (core wires No. 5 and 6). As shown in FIG. 12E, the power wire (core wire No. 7) and the ground wire (core wire No. 8) are placed on both sides of the second differential pair wire (core wires No. 5 and 6), and the CC wire (core wire No. 9) and the Vconn wire (core wire No. 10) may be placed on the opposite side of the second differential pair wire (core wires No. 5 and 6).

In the 9-core communication cable 1 employing the coaxial wires 9a to 9d for the first differential pair wires 2A and 2B, the paired coaxial wires are adjacent to each other as shown in FIG. 12I in the fourth embodiment, but as shown in FIGS. 12H and 12K, a power wire (core wire No. 7) or ground wire (core wire No. 8) may be placed between the paired coaxial wires.

In the 10-core communication cable 1 employing the coaxial wires 9a to 9d for the first differential pair wires 2A and 2B, the paired coaxial wires are adjacent to each other as shown in FIG. 12L in the fifth embodiment, but as shown in FIGS. 12N and 12Q, a power wire (core wire No. 7) or ground wire (core wire No. 8) may be placed between the paired coaxial wires.

The above description is not limited to the above embodiments, but can be varied and implemented in various ways.

### Summary of Embodiments

According to the first feature, a communication cable 1 includes two first differential pair wires 2A, 2B for transmitting high-speed differential signals; a second differential pair wire 3 for transmitting low-speed differential signals; a power wire 4; a ground wire 5; and a configuration channel wire 6 for detecting front and back orientation of a plug 112A, 112B, wherein the communication cable 1 is devoid of other first differential pair wires than the two first differential pair wires 2A, 2B.

According to the second feature, in the communication cable 1, as described by the first feature, includes terminals configured to be electrically connected to the plug 112A, 112B, and the plug 112A, 112B comprises a mating part 112a and pins 112b with a shape and configuration compliant with USB Type-C standard, and the number of terminals of the communication cable 1 that are electrically connected to the pins 112b is less than the number of the pins in the plug compliant with the USB type-C standard.

According to the third feature, the communication cable, as described by the first feature, further includes a power wire for a circuit in the plug.

According to the fourth feature, in the communication cable, as described by the first feature, each of signal wires 2a to 2d constituting the first differential pair wires 2A, 2B has a conductor 21 at a center and an insulation layer 22 covering the conductor 21, and wherein a ratio of a conductor diameter of the conductor 21 to a cable diameter is 0.06 or more.

According to the fifth feature, in the communication cable, as described by the first feature, each of signal wires 2a to 2d constituting the first differential pair wires 2A, 2B has a conductor 21 at a center and an insulation layer 22 covering the conductor 21, and the ratio of a conductor diameter of the conductor 21 to a cable diameter is 0.06 or more and 0.07 or less.

According to the sixth feature, in the communication cable, as described by the third feature, the ratio of a communication distance of the high-speed differential signals to the cable diameter is 800 or more.

According to the seventh feature, in the communication cable, as described by the first feature, the number of core wires is 9 or more and 14 or less.

According to the eighth feature, the communication cable, as described by the first feature, further includes a filler 13 arranged in the vicinity of a cable center.

According to the ninth feature, a communication cable assembly 100 includes the communication cable 1 as described by any one of the first to eighth features, and a pair of plugs 112A, 112B electrically connected to both terminals of the communication cable 1.

1. A communication cable, comprising:
two first differential pair wires for transmitting high-speed differential signals;
a second differential pair wire for transmitting low-speed differential signals;
a power wire;
a ground wire; and
a configuration channel wire for detecting front and back orientation of a plug,
wherein the communication cable is devoid of other first differential pair wires than the two first differential pair wires.

2. The communication cable, according to claim 1, further comprising:
terminals configured to be electrically connected to the plug, wherein the plug comprises a mating part and pins with a shape and configuration compliant with USB Type-C standard, and a number of terminals configured to be connected to the pins is less than a number of pins in a plug compliant with the USB type-C standard.

3. The communication cable, according to claim 1, further comprising:
a power wire for a circuit in the plug.

4. The communication cable, according to claim 1, wherein each signal wire constituting the first differential pair wires has a conductor at a center and an insulation layer covering the conductor, and
wherein a ratio of a conductor diameter of the conductor to a cable diameter is 0.06 or more.

5. The communication cable, according to claim 1, wherein signal wires constituting each of the first differential pair wires have a conductor at a center and an insulation layer covering the conductor, and
wherein a ratio of a conductor diameter of the conductor to a cable diameter is 0.06 or more and 0.07 or less.

6. The communication cable, according to claim 4, wherein a ratio of a communication distance of the high-speed differential signals to the cable diameter is 800 or more.

7. The communication cable, according to claim 1, wherein a number of core wires is 9 or more and 14 or less.

8. The communication cable, according to claim 1, further comprising:
a filler arranged in a vicinity of a cable center.

9. A communication cable assembly, comprising:
the communication cable according to claim 1,
wherein the plug comprises a pair of plugs electrically connected to both terminals of the communication cable.
